(19) United States
(12) Patent Application Publication
(10) Pub. No.: US 2016/0345485 A1
(43) Pub. Date: Dec. 1, 2016

(54) YIELD MONITOR CALIBRATION METHOD AND SYSTEM

(71) Applicant: Raven Industries, Inc., Sioux Falls, SD (US)

(72) Inventors: John Earl Acheson, Sioux Falls, SD (US); Jared Ernest Kocer, Sioux Falls, SD (US)

(21) Appl. No.: 15/081,087

(22) Filed: Mar. 25, 2016

Related U.S. Application Data
(63) Continuation of application No. PCT/US2014/057791, filed on Sep. 26, 2014.
(60) Provisional application No. 61/883,899, filed on Sep. 27, 2013.

(51) Int. Cl. A01B 79/00; G01D 18/00; A01D 41/127

(52) U.S. Cl. CPC A01B 79/005; A01D 41/127; G01D 18/00

(57) ABSTRACT

The present disclosure relates to a methods and systems for calibrating a yield monitor. The method includes delivering a first harvested crop load from a first harvester to a cart, the first harvester including a harvester yield monitor and the cart including a cart sensor. A harvested crop characteristic of the first harvested crop load is measured with the yield monitor. The method includes calibrating the harvester yield monitor based on the harvested crop characteristic and a true crop characteristic and repeating the calibrating with on-going delivering of at least one subsequent harvested crop load from the first harvester to the cart and measuring of a subsequent harvested crop characteristic.

### CLAIM OF PRIORITY

This application is a U.S. National Stage Filing under 35 U.S.C. 371 from International Application No. PCT/US2014/057791, filed on 26 Sep. 2014, and published as WO 2015/048499 A1 on 2 Apr. 2015, which application claims the benefit of priority of U.S. Provisional Patent Application Ser. No. 61/883,899, filed on Sep. 27, 2013, which applications and publications are incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries; Sioux Falls, S. Dak.; All Rights Reserved.

### TECHNICAL FIELD

This document pertains generally, but not by way of limitation, to a crop cart scale system and a harvester yield monitor.

### BACKGROUND

Agricultural crops, such as grains, fruits, vegetables, nuts, cotton, and tobacco, are typically collected by a harvester, such as a combine. In some examples, combines include a yield monitor to measure crop yields during harvesting. Yield monitor systems determine one or more properties of the crop as it is being collected. Yield monitors may require periodic calibrations, for instance for a mass-flow sensor or a moisture sensor. In one example, a method for calibrating a yield monitor includes a user tracking numerous moisture values and manually inputting the tracked moisture values in the yield monitor system. This method can be time consuming and may insert human error into the process. Further, the accuracy of the yield monitor system is based on the frequency of inserted moisture values.

### OVERVIEW

Previous crop harvesting operations include collecting and measuring a crop characteristic with a harvester to determine a crop yield. The harvested crop is transferred to either a staging area or an elevator for storage. At that time, for example, the crop is the re-measured with a more accurate measuring system to determine a true crop measurement. These true crop measurements are manually recorded by a user and relayed back to the harvester in the field in order to recalibrate the yield measurement system onboard the harvester.

The present inventors have recognized, among other things, that a problem to be solved can include the inefficiency and irregularity of calibrating a harvester yield monitor. In an example, the present subject matter can provide a solution to this problem, such as by a system including a cart with a remote sensor configured to more accurately, as compared to the yield monitor, measure a crop characteristic. The harvester unloads the harvested crop in the cart such that the remote sensor is triggered. The measurements of the remote sensor and yield monitor can be compared to provide calibration information to the yield monitor.

The present inventors have recognized, among other things, that a problem to be solved can include the inaccuracy of current harvester yield monitor calibration methods. In an example, the present subject matter can provide a solution to this problem, such as by removing the need for a user to manually input crop characteristics into a system. Such a system removes a source of human error, thereby increasing accuracy of the calibration system and method.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is perspective view of one example of a harvester and cart.

FIG. 2 is a flow diagram of a yield monitor calibration system.

FIG. 3 is one example of a field moisture content map including crop moisture content values associated with corresponding field locations.

FIG. 4 is a block diagram showing one example of a method for calibrating a yield monitor.

FIG. 5 is a block diagram showing an alternative example of a method for calibrating a yield monitor.

### DETAILED DESCRIPTION

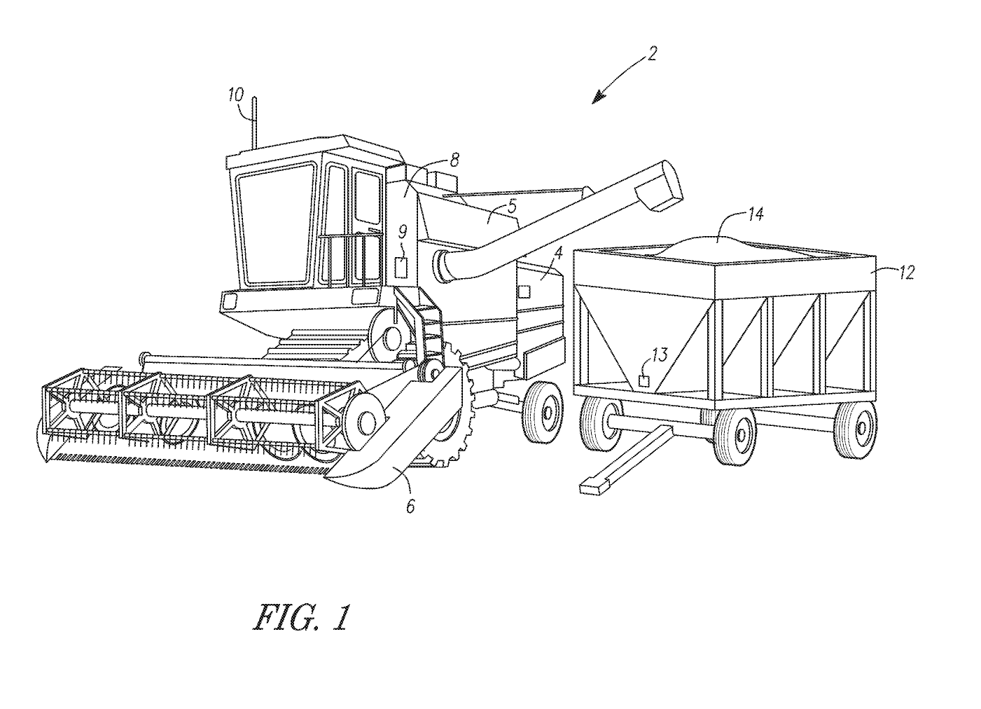

FIG. 1 shows one example of a harvester, such as a harvester combine 2, and a cart, such as a grain cart 12. As shown, the harvester 2 includes a body 4 and a header 6 movably coupled with the body 4. In one example, the header 6 cuts and divides crops and delivers harvested crops 14 into the body 4 for further processing. As further shown in FIG. 1, an antenna such as a GPS antenna 10 is further provided on the body 4 to provide accurate position data of the harvester 2, for instance while harvesting within a field. The harvester 2 includes a harvester elevator 8 configured to transport the harvested crop 14 within the harvester 2 and to the cart 12. For instance, harvester elevator 8 includes, but is not be limited to, a combine elevator, fruit picking conveyor, nut conveyor, or another system that generates an ongoing flow of the harvested crop 14. In an example, the harvester elevator 8 includes a harvester boom to deliver the harvested crop 14 to the cart 12.

The harvester 2 includes a harvester yield monitor 9. In an example, the harvester yield monitor 9 is included on or as part of as at least one of the harvester elevator 8, the body 4, the harvester boom 7, and the header 6. In an example, the harvester yield monitor 9 is a component of a harvester yield monitor system including, for example, a receiver, a wireless transmitter, various sensors, as described herein, and a processing node configured to measure a harvested crop characteristic of the harvested crop 14. That is to say, the harvester yield monitor 9 is part of the harvester yield monitor system provided as a standalone system for installation with a harvester or is provided with the harvester during manufacture of the harvester. The harvester yield monitor 9 described herein in communication with one or more yield monitor sensors that measures at least one of crop weight, crop moisture, crop temperature, and volume of harvested crop.

In an example, the harvester yield monitor 9 of the harvester 2 includes one or more sensors for determining one or more harvested crop characteristics (e.g., a suite of sensors in an example). In one example the harvester yield monitor 9 includes an optical sensor (e.g., a photo eye, an infrared sensor, or the like) optionally installed in the harvester elevator 8 to measure a volume of the harvested crop 14. In another example, the harvester yield monitor 9 includes a weight sensor (also optionally installed in the harvester elevator 8) including, but not limited to, a load cell, strain gauge, a piezo element, strike plate or the like, to measure a weight of the harvested crop 14. In another example, the harvester yield monitor 9 includes a moisture sensor including, but not limited to, a frequency domain sensor, a capacitance sensor, a neutron moisture gauge, time domain transmission, time domain reflectometry sensor, and the like. Further, the harvester yield monitor 9 includes a temperature sensor in one or more examples. The harvester yield monitor 9 is configured to measure the harvested crop characteristic in real-time (e.g., immediately at the time of harvesting of an instant crop or immediately thereafter). That is, the harvester yield monitor 9 and the sensors associated with the monitor are placed in-line with the harvester 2 and the harvested crop characteristic is measured concurrently with the harvesting operation. In an example, the sensors of the harvester yield monitor 9 is located in one or more of a cab of the harvester (e.g., a location occupied by an operator), the header 6, harvester elevator 8 or the harvester boom 7 to measure the harvested crop characteristic while the harvested crop 14 flows through the harvester 2. In another example, one or more of the sensors of the harvester yield monitor 9 are included in a harvester tank 5 to measure the one or more harvested crop characteristics in a batch process. A batch process includes harvesting crop for a designated time, yield, or acreage before transporting the harvested crop 14 to the cart 12.

Although the systems and methods described herein are shown in the context of an exemplary harvester 2, the disclosure is not limited to harvesters 2. Instead, the systems and methods are applicable to any system (whether static or moving) that would benefit from accurate crop characteristic measurements of a crop. For instance, the systems and methods described herein are used with, but not limited to, stationary harvesters, elevators, crop picking systems (e.g., fruit and apple picking systems) and the like. In an example, the yield monitor calibration systems and methods include a plurality of harvesters, such as, for example, one master harvester and one or more drone harvester or a plurality of independently acting harvesters.

The cart 12 includes a cart sensor 13. The cart sensor 13 measures one or more true crop characteristics of the harvested crop 14. In an example, the true crop characteristics correspond to respective harvested crop characteristics (e.g., weight, moisture, volume, etc.). In another example, the true crop characteristic is a measured value that is manipulated to provide a resulting value in units corresponding to that of the harvested crop characteristic. As described herein, the cart sensor 13 is part of a cart sensor system including, in an example, a wireless transmitter to communicate with a wireless data link of the harvester yield monitor 9. In one or more example the he wireless transmitter includes near field communication, radio frequency identification, Bluetooth, personal area networks, wireless communication connections, and combinations thereof. In an example, the true crop characteristic more accurately reflects the measured characteristic of the harvested crop 14. In an example, the cart sensor 13 is a stationary sensor (stationary relative to the cart 12) that measures static crops and thereby has greater accuracy than a harvester yield monitor 9. As discussed in detail herein, the true crop characteristic is compared to the harvested crop characteristic to provide at least one of a comparison and a calibration instruction based on the comparison to thereby provide accurate real-time yield measurements from the yield monitor. Providing accurate yield measurements ensures accurate mapping of yield across a field and further improves the overall accuracy of harvest calculations for the field in general. As further discussed herein, the comparison and resulting calibration instruction is conducted by either or both of the cart sensor system or the harvester yield monitor system. Where calibration is discussed herein calibration includes, but is not limited to, providing a calibration instruction for the yield monitor to accordingly calibrate the measurement or determination of one or more of the harvested crop characteristics or yield values associated with the harvested crop characteristics.

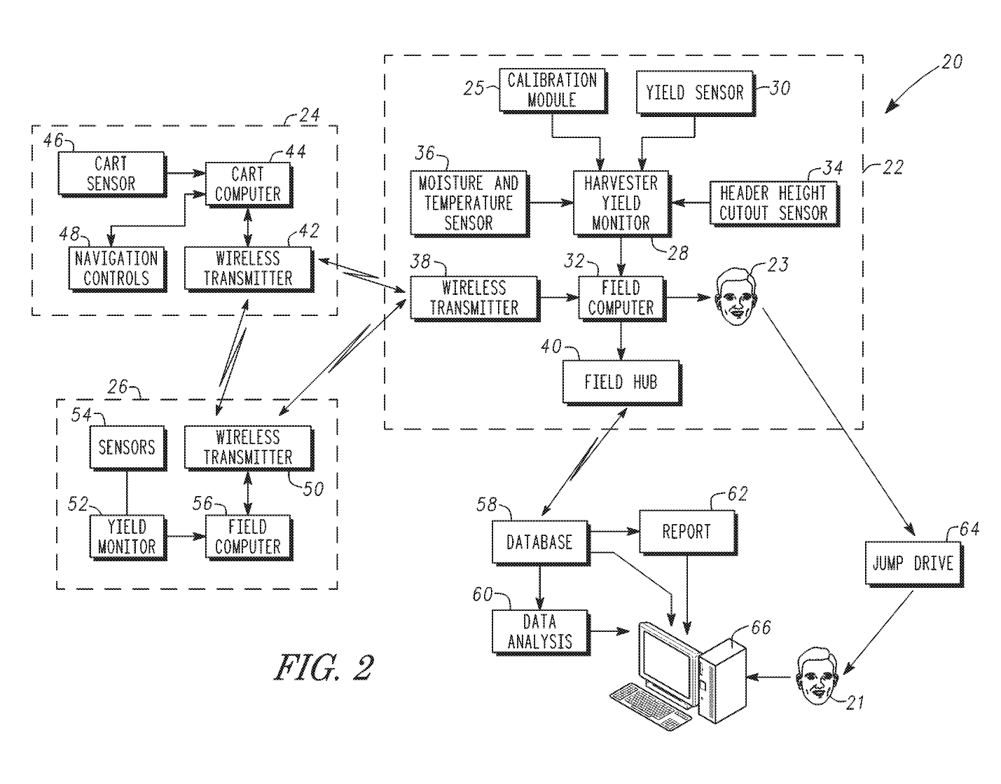

FIG. 2 shows an example yield monitor calibration system 20. The exemplary yield monitor calibration system 20 is optionally included with a first harvester 22 including a harvester yield monitor 28 as part of an overall harvester yield monitor system (e.g., corresponding to one or more of the components within the box corresponding to the first harvester 22), as described herein. In operation, the first harvester 22 is operated by an operator 23. In an example, the first harvester 22 includes a number of sensors, including, but not limited to, a yield sensor 30 (e.g., one or more of weight or volume sensors), a moisture and temperature sensor 36, a header height cutout sensor 34 or the like. Any one or combination of the sensors 30, 34, 36 measure characteristics corresponding (directly or through processing) to one or more harvested crop characteristics monitored (and optionally computed) by the yield monitor 28. As shown in the example provided in FIG. 2, the yield monitor 28 is communicatively coupled to a field computer 32. In the example, the field computer 32 displays one or more of the measured harvested crop characteristic (or plural characteristics such as weight, volume, temperature, moisture, header height or the like), yield measurement (or plural measurements) from the yield monitor 28. Further, as described herein, the field computer 32 is configured, in an example, to provide a calibration instruction to the yield monitor 28 to enhance the accuracy of one or more of the measured harvested crop characteristics, yield values provided by the yield monitor 28 or the like.

In an example, the first harvester 22 includes a wireless transmitter 38 (as optionally part of a harvester yield monitor system) configured to communicate with a cart 24 (the cart sensor system corresponding to the dashed box shown) or a second harvester 26. In one or more example the he wireless transmitter 38 includes near field communication, radio frequency identification, Bluetooth, personal area networks, wireless communication connections, and combinations thereof. Although FIG. 2 shows one harvester (e.g., the second harvester 26) in addition to the first harvester 22 examples are not so limited, as will be discussed herein. The wireless transmitter 38 facilitates the communication of calibration information (values, comparison data or the like) to the yield monitor 28 for calibration of the yield monitor 28 as discussed herein. As discussed herein, the first harvester 22 transfers the harvested crop (14, FIG. 1) to the cart 24. A cart sensor 46 of the cart 24 (as part of a cart sensor system including one or more the modules shown in FIG. 2 and associated with the cart 24) measures at least one true crop characteristic (e.g., a crop characteristic, characteristic corresponding to a yield value or the like) of the harvested crop. In an example, a cart wireless transmitter 42 transmits the true crop characteristic to the yield monitor 28 of the first harvester 22 (e.g., as part of a harvester yield monitor system), the second harvester 26, or both harvesters 22, 26. In an example, the cart sensor system of the cart 24 includes a cart computer 44 configured to compare the measured true crop characteristic to the measured harvested crop characteristic to produce a comparison. In an example, the cart wireless transmitter 42 transmits the comparison to the first harvester 22, the second harvester 26, or both harvesters 22, 26. In an example, the cart computer 44 provides a calibration instruction based on the comparison and the cart wireless transmitter 42 transmits the calibration instruction to the first harvester 22, the second harvester 26, or both harvesters 22, 26. In an example, the wireless transmitter 42 of the cart sensor system of the cart 24 transmits the measured true crop characteristic to the harvester sensor system of the first harvester 22, such that the field computer 32 or the harvester yield monitor 28 performs the comparison of the true crop characteristic and the measured harvested crop characteristic, generates the calibration instruction, or both. In one or more example, the cart sensor system of the cart 24, the harvester sensor system of the first harvester 22, or both includes a comparator to perform the comparison of the measured harvested crop characteristic with the measured true crop characteristic. The comparator, for example, is included in the field computer 32, the cart computer 44, or both. Further, in an example, system 20 includes a calibration module 25 to calibrate the yield monitor 28 based on a comparison of the harvested crop characteristic and the true crop characteristic. In various examples, the cart sensor system of the cart 24, the harvester sensor system of the first harvester 22, or both includes a calibration instruction module to generate the calibration instruction for the harvester yield monitor based on the comparison.

Further, in an example, the cart 24 includes navigation controls 48 to aid in directing the cart 24 relative to the first harvester 22 or the second harvester 26. In an example, the navigation controls module 48 are used in combination with the GPS antenna (10, FIG. 1) of the harvester to produce a field yield map including crop yield values associated with corresponding field locations, as discussed herein. In an example, the first harvester 22 includes a corresponding navigation controls module. For example, the navigation controls module of the first harvester 22 permits continuous dumping of the harvested crop from the first harvester 22 to the cart 24 without having to stop for a dedicated unloading procedure of the harvested crop. A benefit of such an embodiment includes an increase in harvesting efficiency.

As shown in FIG. 2, the second harvester 26 includes a wireless transmitter 50 configured to communicate with one or more of the cart wireless transmitter 42 or the harvester wireless transmitter 38. In an example, the second harvester 26 is a drone harvester. That is, the second harvester 26 receives the comparison, the calibration instructions, or both from the cart 24 or the first harvester 22. In such an example, a field computer 56 of the second harvester 26 uses the comparison, the calibration instructions, or both based on the one or more measured harvested crop characteristics of the first harvester 22 (and corresponding one or more measured true crop characteristics) to calibrate the yield monitor 52 of the second harvester 26. For example, one or more sensors of sensors 54 of the second harvester 26 measures a second harvester harvested crop characteristic to the yield monitor 52 that is adjusted by the yield monitor 52 according to information (e.g., the comparison, calibration instructions, or both) received from the cart 24 or the first harvester 22.

In an example, the second harvester 26 acts independently of the first harvester 22. For example, (in a similar manner to the first harvester 22) the second harvester 26 measures a harvested crop characteristic of a crop harvested by the second harvester 26. A comparison between harvested crop of the second harvester 22 and a true crop characteristic of the harvested crop of the cart 24 is produced in a similar manner to the method for producing the comparison with the first harvester 26 and the crop harvested from it. The same method is used for developing a calibration instruction for the yield monitor 52 of the second harvester. In other words, the components of the yield monitor calibration system 20, in an example, provide a calibration instruction or a comparison unique to each harvester 22, 26.

In an example, the field hub 40 of the first harvester 22 is communicatively coupled, such as wirelessly, to the database 58. The database 58, for example, is used to produce a report 62 of a series of the comparisons, calibration instructions, or both produced by the cart 24, first harvester 22, or both. In an example, the database 58 is analyzed, such as by statistical analysis, to determine if any trends are present in the data (e.g., the data provided in the report 62) which indicates any equipment failure or potential failures. In one or more examples, the database 58, the report 62, or the data analysis module 60 is provided to a computer 66 accessible by the operator 23 or another individual 21. As discussed herein, the report 62, data analysis module 60, or database 58 is used to provide historical comparisons, calibration instructions, or both to the first harvester 22 to calibrate the yield monitor 32. For example, the system 20 includes a historical comparison module, such as database module 58, report module 62, or data analysis module 60, configured to store a plurality of comparisons as a comparison log and the historical comparison module generates a historical comparison value based on the comparison log, as discussed herein. In one or more example, the system 20 includes a historical calibration instruction module, such as database module 58, report module 62, or data analysis module 60, the historical calibration instruction module stores a plurality of calibration instructions as a calibration instruction log, the plurality of calibration instructions based on the comparison and the historical calibration instruction module generates a historical calibration value based on the calibration instruction log, as described herein. In such examples, the calibration module 25 is in communication with the historical comparison module and the historical calibration instruction module.

In an example, a jump drive 64 or the like is used to provide the computer 66 with the series of the comparisons, calibration instructions, or both produced by the cart 24, first harvester 22, or both. In one or more examples, the database 58 is communicatively coupled with more than one harvester, such as the second harvester 26. In an example, the database 58, the report 62, the data analysis module 60, or any combination thereof is used to produce a yield map, as described herein.

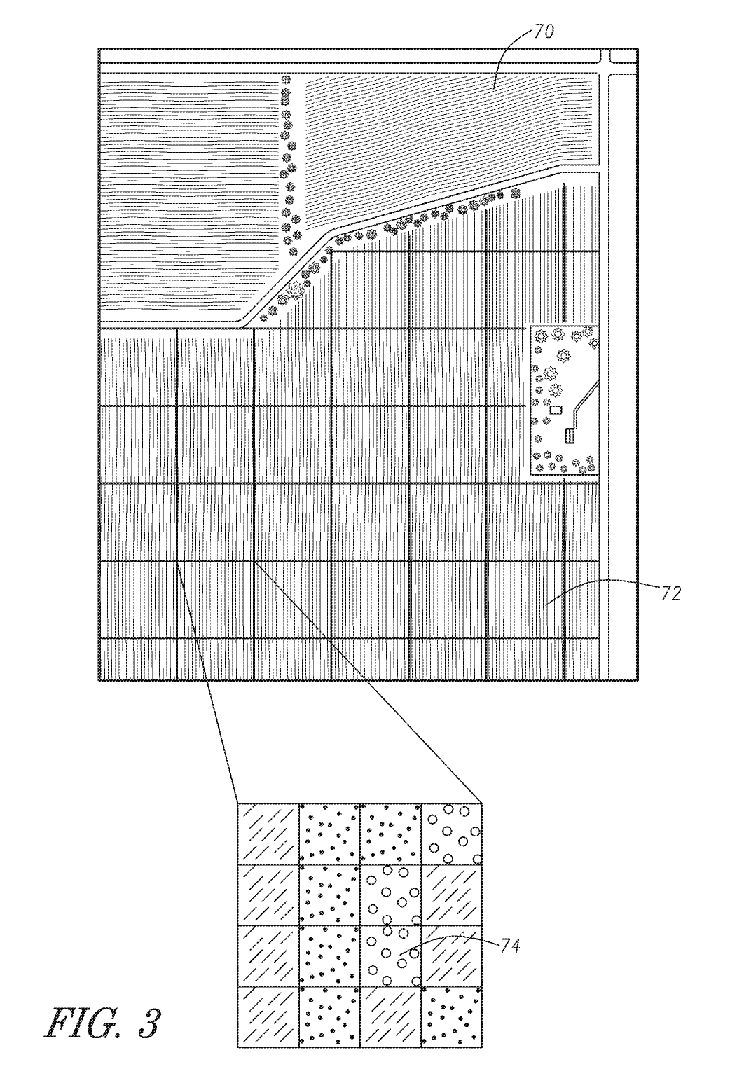

FIG. 3 is a demonstrative example of a crop characteristic map 70. Optionally the yield map 70 includes but is not limited to providing a visual representation of the true crop characteristic, comparison, calibration instruction, or any combination thereof. A zoomed in portion of the yield map 70 is shown in the bottom view of FIG. 3. As shown by way of varying stippling, shading, or the like a plurality of zones 72 accordingly has corresponding true crop characteristics (e.g., moisture, yield, volume, temperature, etc.), magnitude of the comparison, or type of calibration instruction. For instance, as shown in FIG. 3, a plurality of zones 72 having a varying true crop characteristic are associated with the one or more zones 72. Accordingly each of the zones 72 includes in one example an array of information including the true harvested crop characteristic. The crop characteristic map 70 accordingly provides a representation to the operator of the true harvested output provided during a harvesting operation. Information provided by the crop characteristic map 70 is optionally used for instance to determine better husbandry techniques, planting strategies and the like for the field in the next season.

Referring again to FIG. 3, the plurality of zones 72 include sub-zones 74. As shown, each of the zones and sub-zones has different stippling, shading or the like associated with the true harvested crop characteristic. Optionally the sub-zones 74 (or any of the plurality of zones 72) have varying stippling, shading or coloring techniques or any combination thereof to accordingly provide indications of calibration instructions, magnitude of comparisons, or both. As shown in FIG. 3, by way of the stippling, shading, coloring or the like the true harvested crop characteristic varies between each of the zones 72. As shown for instance, each of the sub-zones 74 the stippling is different between the zones thereby indicating true harvested crop characteristic, such as moisture content, there between varies. Optionally the yield map 70 provides one or more interactive zones 72. For instance the user is able to zoom in and examine each of the zones 72 accordingly allowing for instance through a graphical user interface interaction with the crop characteristic field map 70 to accordingly determine the true crop characteristic of one or a plurality of the zones 72. In an example, the crop characteristic map 70 is adjusted based on at least one of the comparison and the calibration instruction, as described herein.

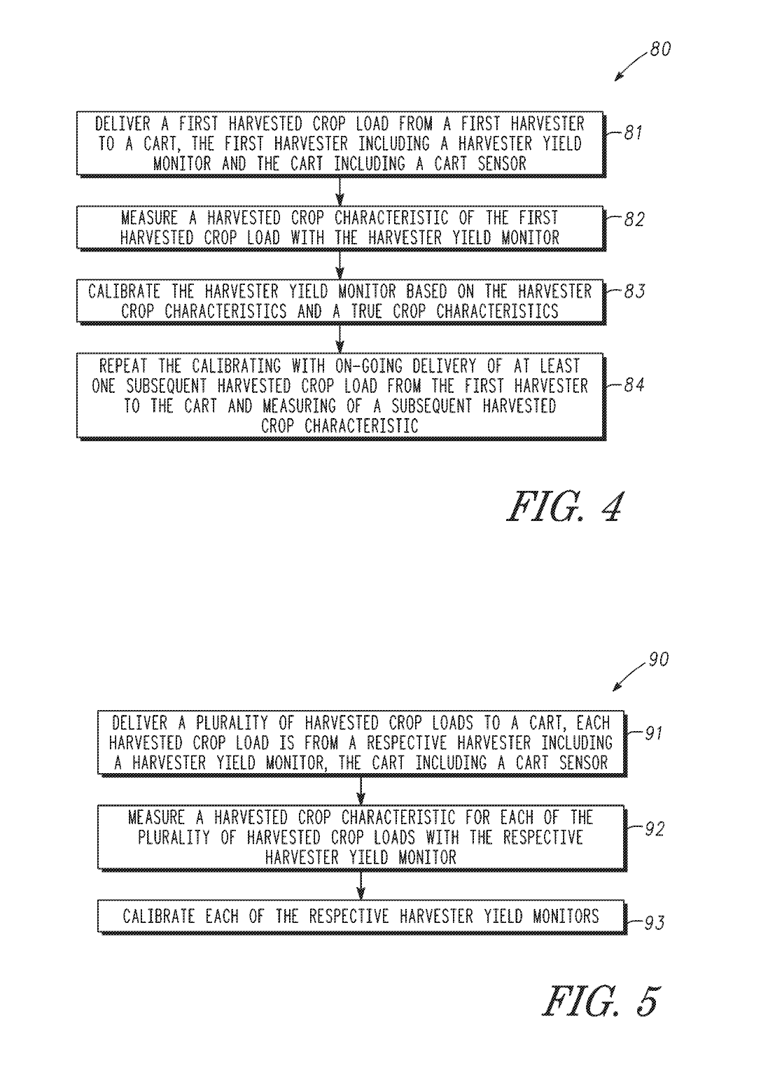

FIG. 4 shows a block diagram illustrating one example of a method 80 for calibrating a yield monitor. In describing the method 80, reference is made to features and elements previously described herein, although not numbered. At 81, the method 80 includes delivering a first harvested crop load from a first harvester to a cart, the first harvester including a harvester yield monitor and the cart including a cart sensor. For example, as previously described herein, the harvester includes a harvester elevator configured to transport the harvested crop within the harvester and to the cart. For instance, the harvester elevator includes, but is not be limited to, a combine elevator, fruit picking conveyor, nut conveyor, or another system that generates an ongoing flow of the harvested crop. In an example, the harvester elevator includes a harvester boom to deliver the harvested crop to the cart. For example, delivering the first harvested crop load includes delivering at least one of grains, fruits, vegetables, nuts, cotton, and tobacco. In one or more example, the cart includes one of a truck, a crop cart, a tractor, a semi-trailer, or an elevator.

At 82, a harvested crop characteristic of the first harvested crop load is measured with the harvester yield monitor. In an example, the harvester yield monitor of the harvester includes one or more sensors for determining one or more harvested crop characteristics (e.g., a suite of sensors in an example). In one example, the harvester yield monitor includes an optical sensor (e.g., a photo eye, an infrared sensor, or the like), a weight sensor (e.g., a load cell, strain gauge, a piezo element, strike plate or the like) to measure a weight of the harvested crop, a moisture sensor (e.g., a frequency domain sensor, a capacitance sensor, a neutron moisture gauge, time domain transmission, time domain reflectometry sensor, and the like), or a temperature sensor. In an example, the measuring of the harvested crop characteristic is performed in real-time (e.g., immediately at the time of harvesting of an instant crop or immediately thereafter) or in a batch process. As described herein, the harvester yield monitor, in an example, is a component of the harvester yield module system (e.g., corresponding to one or more of the components within the box corresponding to the first harvester).

At 83, the harvester yield monitor is calibrated based on the harvested crop characteristic and a true crop characteristic. In an example, the calibrating includes measuring the true crop characteristic of the first harvested crop load with the cart sensor. The cart sensor, in an example, is a component of the cart sensor system including one or more the modules shown in FIG. 2 and associated with the cart. As described herein, the cart sensor includes a sensor configured to measure the true crop characteristic corresponding to the harvested crop characteristic (e.g., weight, moisture content, temperature, volume, and the like). Further, in one or more examples, the calibrating includes comparing the true crop characteristic to the harvested crop characteristic measured with the yield monitor of the first harvester. The comparison, in an example, is performed by a comparator, as described herein. Comparing the true crop characteristic to the harvested crop characteristic includes at least one of averaging, including a weighted average, determining a difference, or a similar statistical comparison. The comparison is performed by a component, such as the comparator, of the cart sensor system or the harvester yield module system. Further, in an example, the calibrating is based on the comparison. In an example, the method 80 includes transmitting the true crop characteristic to the first harvester, such that the yield monitor system or a component thereof (e.g., the yield monitor, the field computer) of the first harvester performs the comparison. In an example, the method 80 includes transmitting a calibration instruction based on the comparison to the first harvester, such that the cart sensor system or a component thereof performs the comparison. The calibration instruction includes, in an example, programmable instructions related to the respective comparison, so as to adjust the measured harvested crop characteristic to more accurately reflect the true crop characteristic measurement.

At 84, the method 80 includes repeating the calibrating with on-going delivering of at least one subsequent harvested crop load from the first harvester to the cart and measuring of a subsequent harvested crop characteristic. That is, the calibration of the yield monitor is progressively updated based on on-going delivery of subsequent harvested crop loads. A benefit of such an example includes providing an accurate yield monitor for use during harvesting operations.

In another example, the method for calibrating includes calibrating one or more drone harvesters based on the calibration of the yield monitor of a first harvester. In such an example, the calibration instruction generated for the first harvester is transmitted to the one or more drone harvester and is used to calibrate the respective yield monitor of the drone harvesters.

In an example, the method for calibrating includes calibrating a number of independent harvesters in addition to the first harvester. For example, the method includes measuring a true crop characteristic of a plurality of harvested crop loads from a plurality of harvesters in addition to the first harvester. The true crop characteristics of each of the plurality of harvested crop loads in addition to the first harvested crop load are compared, in an example, to respective yield monitor crop characteristics of each of the plurality of harvesters including the first harvester. In such an example, the method includes calibrating the yield monitor of each of the plurality of harvesters based on the respective comparison of each the plurality of yield monitor crop characteristics and true crop characteristics. That is, each harvester of the plurality of harvesters is configured to calibrate its respective yield monitor using one cart including a cart sensor system, described herein.

In one or more example, the method for calibrating includes calibrating a number of harvesters including the first harvester, such as based on a normalized comparison. In such an example, a true crop characteristic is measured with the cart sensor of each of a plurality of harvested crop loads from a plurality of harvesters other than the first harvester. The method includes, for example, comparing the true crop characteristics of each of the plurality of harvested crop loads other than that of the first harvester to respective yield monitor crop characteristics of each of the plurality of harvesters to provide a plurality of comparisons. The plurality of comparisons include, for example, any form of statistical analysis described herein, such as averaging (including weighted averaging) or determining a difference. Further, the method includes determining a normalized comparison from the plurality of comparisons and the comparison associated with the first harvester. A normalized comparison includes a single value or calibration instruction that takes into account the plurality of comparisons and the comparison associated with the first harvester. For example, a normalized comparison includes one of an average, a weight average, a midrange, a mean, a trimean, a mode, and the like. As discussed herein, the calibration instruction includes at least one of a percentage variation the measured harvested crop characteristic should change to more accurately reflect the true crop characteristic or a numerical value the measured harvested crop characteristic should change to more accurately reflect the true crop characteristic, or the like. In such an example, the yield monitor of each of the plurality of harvesters and the first harvester is calibrated based on the normalized comparison

In an example, the comparison, the calibration instruction, or both are transmitted, such as by a wireless transmitter, described herein to a database. In an example, the database includes a plurality of comparisons logged so as to provide a comparison log. The comparison log, in an example, is analyzed (such as by the data analysis module of FIG. 2) to determine a historical comparison. The historical comparison includes a value based on comparisons of the first harvester alone or a plurality of harvesters. For example, the historical comparison includes an average of historical comparisons, an average of average historical comparisons, or any statistical analysis of comparisons discussed herein. In such an example, the historical comparison is provided to the first harvester, so as, for example, to be used for calibrating the yield module of the first harvester or one or more additional harvesters.

In an example, the method 80 includes storing a plurality of calibration instructions as a calibration instruction log. The plurality of calibration instructions are based, for example, on comparisons between harvested crop characteristics and corresponding true crop characteristics, such as of the first harvester. The calibration instruction log, in an example, is stored, generated, or both by a module (e.g., database module, report module, data analysis module of FIG. 2) or a computer (computer 66 of FIG. 2). In such an example, the method includes generating a historical calibration value based on the calibration instruction log. As described herein, generating the historical calibration value includes using at least one statistical analysis including, but not limited to, an average, a weight average, a midrange, a mean, a trimean, a mode. The yield monitor of the first harvester, for example, is calibrated based on the historical calibration value.

In one or more example the comparison, the historical comparison, the calibration instruction, the historical calibration instruction, the measured true crop characteristic, the measured harvest crop characteristic, the comparison log, the calibration instruction log, or any combination thereof is used to produce a crop characteristic map, such as described herein. Further, in an example, at least one of the comparison and the calibration instruction is used to adjust or modify the harvested crop yield map to more accurately reflect the actual yield (or other mapped crop characteristic). That is, in an example, the method 80 includes adjusting the measured yield monitor crop characteristics of respective previously harvested crop loads based on the calibrating.

FIG. 5 shows a block diagram illustrating one example of a method 90 for calibrating a plurality of yield monitors. In describing the method 90, reference is made to features and elements previously described herein, although not numbered. At 91, the method includes delivering a plurality of harvested crop loads to a cart, wherein each harvested crop load is from a respective harvester including a harvester yield monitor and the cart including a cart sensor. In one or more example, the plurality of harvesters includes drones, independent, or combinations thereof, as described herein. At 92, the method includes measuring a harvested crop characteristic for each of the plurality of harvested crop loads with the respective harvester yield monitor. Further, each of the respective harvester yield monitors is calibrated, at 93.

In one or more example, calibrating includes measuring the true crop characteristic of each of the plurality of harvested crop loads with the cart sensor and comparing the true crop characteristic to the harvested crop characteristic to provide a comparison. Each yield monitor of a respective on of the plurality harvesters is calibrated based on the comparison. In such an example, the comparison is unique to each of the respective yield monitors or the comparison is applicable to every yield monitor of the plurality of harvesters. For example, the comparison includes calculating an average discrepancy between a total of each of the measured true crop characteristics and a total of each of the measured harvested crop characteristics. In one or more example, any statistical method described or reference herein is used for the comparison.

### NOTES AND EXAMPLES

Example 1 can include subject matter (such as an apparatus, a method, a means for performing acts, or a machine readable medium including instructions that, when performed by the machine, that can cause the machine to perform acts), such as a method for calibrating a yield monitor, comprising: delivering a first harvested crop load from a first harvester to a cart, the first harvester including a harvester yield monitor and the cart including a cart sensor; measuring a harvested crop characteristic of the first harvested crop load with the harvester yield monitor; calibrating the harvester yield monitor based on the harvested crop characteristic and a true crop characteristic, the calibration including: measuring the true crop characteristic of the first harvested crop load with the cart sensor, comparing the true crop characteristic to the harvested crop characteristic measured with the yield monitor of the first harvester, and calibrating the yield monitor of the first harvester based on the comparison; and repeating calibrating with on-going delivering of at least one subsequent harvested crop load from the first harvester to the cart and measuring of a subsequent harvested crop characteristic.

Example 2 can include, or can optionally be combined with the subject matter of Example 1 to optionally include measuring a true crop characteristic of each of a plurality of harvested crop loads from a plurality of harvesters in addition to the first harvester; comparing the true crop characteristics of each of the plurality of harvested crop loads in addition to the first harvested crop load to respective yield monitor crop characteristics of each of the plurality of harvesters including the first harvester; and calibrating the yield monitor of each of the plurality of harvesters based on the respective comparison of each the plurality of yield monitor crop characteristics and true crop characteristics.

Example 3 can include, or can optionally be combined with the subject matter of one or any combination of Examples 1 or 2 to optionally include measuring a true crop characteristic with the cart sensor of each of a plurality of harvested crop loads from a plurality of harvesters other than the first harvester; comparing the true crop characteristics of each of the plurality of harvested crop loads other than that of the first harvester to respective yield monitor crop characteristics of each of the plurality of harvesters to provide a plurality of comparisons; and determining a normalized comparison from the plurality of comparisons and the comparison associated with the first harvester; calibrating the yield monitor of each of the plurality of harvesters and the first harvester based on the normalized comparison.

Example 4 can include, or can optionally be combined with the subject matter of one or any combination of Examples 1-3 to optionally include calibrating a yield monitor of each of a plurality of harvesters including than the first harvester based on the comparison associated with the first harvester.

Example 5 can include, or can optionally be combined with the subject matter of one or any combination of Examples 1-4 to optionally include wherein measuring the yield monitor crop characteristic and the true crop characteristic includes measuring at least one of a crop weight, a crop moisture content, a crop temperature, and a crop volume.

Example 6 can include, or can optionally be combined with the subject matter of one or any combination of Examples 1-5 to optionally include transmitting the true crop characteristic to the first harvester, such that the yield monitor performs the comparing.

Example 7 can include, or can optionally be combined with the subject matter of one or any combination of Examples 1-6 to optionally include transmitting the comparison from the first harvester to a database.

Example 8 can include, or can optionally be combined with the subject matter of one or any combination of Examples 1-7 to optionally include logging a plurality of comparisons to provide a comparison log: analyzing the comparison log to determine a historical comparison; and providing the historical comparison to the first harvester.

Example 9 can include, or can optionally be combined with the subject matter of one or any combination of Examples 1-8 to optionally include transmitting a calibration instruction based on the comparison to the first harvester, such that the cart performs the comparing.

Example 10 can include, or can optionally be combined with the subject matter of one or any combination of Examples 1-9 to optionally include storing a plurality of calibration instructions as a calibration instruction log, the plurality of calibration instructions based on comparisons between harvested crop characteristics and corresponding true crop characteristics; generating a historical calibration value based on the calibration instruction log; and wherein calibrating the yield monitor of the first harvester based on the comparison includes calibrating the yield monitor with the historical calibration value.

Example 11 can include, or can optionally be combined with the subject matter of one or any combination of Examples 1-10 to optionally include adjusting the measured yield monitor crop characteristics of respective previously harvested crop loads based on the calibrating.

Example 12 can include, or can optionally be combined with the subject matter of one or any combination of Examples 1-11 to optionally include adjusting a harvested crop yield map based on the calibrating.

Example 13 can include, or can optionally be combined with the subject matter of one or any combination of Examples 1-12 to optionally include wherein delivering the first harvested crop load includes delivering at least one of grains, fruits, vegetables, nuts, cotton, and tobacco.

Example 14 can include, or can optionally be combined with the subject matter of one or any combination of Examples 1-13 to optionally include wherein delivering the first harvested crop to the cart includes delivering to one of a truck, a crop cart, a tractor, a semi-trailer, or an elevator.

Example 15 can include subject matter (such as an apparatus, a method, a means for performing acts, or a machine readable medium including instructions that, when performed by the machine, that can cause the machine to perform acts), such as a system for remotely calibrating a yield monitor, comprising: a harvester yield monitor configured for installation with a first harvester, the harvester yield monitor measures a harvested crop characteristic of a first harvested crop load; a cart sensor configured for installation with a cart, the cart sensor measures a true crop characteristic of the first harvested crop load: and a calibration module in communication with the harvester yield monitor and the cart sensor, the calibration module includes: a comparator, the comparator compares the measured harvested crop characteristic with the measured true crop characteristic, and a calibration instruction module, the calibration instruction module generates a calibration instruction for the harvester yield monitor based on the comparison.

Example 16 can include, or can optionally be combined with the subject matter of Example 15 to optionally include the calibration module further comprised to compare the true crop characteristic to the yield monitor crop characteristic and determine a calibration instruction.

Example 17 can include, or can optionally be combined with the subject matter of one or any combination of Examples 15 or 16 to optionally include a plurality of harvesters other than the first harvester, each of the plurality of harvesters includes a respective yield monitor, wherein the first harvester transmits at least one of the comparison and the calibration instruction to each of the plurality of harvesters.

Example 18 can include, or can optionally be combined with the subject matter of one or any combination of Examples 15-17 to optionally include a historical comparison module, the historical comparison module stores a plurality of comparisons as a comparison log and the historical comparison module generates a historical comparison value based on the comparison log; and a historical calibration instruction module, the historical calibration instruction module stores a plurality of calibration instructions as a calibration instruction log, the plurality of calibration instructions based on the comparison and the historical calibration instruction module generates a historical calibration value based on the calibration instruction log,

wherein the calibration module is in communication with the historical comparison module and the historical calibration instruction module.

Example 19 can include subject matter (such as an apparatus, a method, a means for performing acts, or a machine readable medium including instructions that, when performed by the machine, that can cause the machine to perform acts), such as a method for calibrating a plurality of harvester yield monitors, each harvester yield monitor being associated with a different harvester, comprising: delivering a plurality of harvested crop loads to a cart, each harvested crop load being from a different harvester; measuring a harvested crop characteristic for each of the plurality of harvested crop loads with a respective harvester yield monitor of a respective harvester; and measuring a true crop characteristic for each of the plurality of harvested crop loads with the cart sensor, comparing each measured true crop characteristic to a respective measured harvested crop characteristic to provide a comparison for each of the plurality of harvested crop loads, and calibrating each respective yield monitor of the plurality of harvesters based on the comparison for harvested crop load associated with the respective yield monitor.

Example 20 can include, or can optionally be combined with the subject matter of Example 19 to optionally include wherein comparing includes calculating an average discrepancy between a total of each of the measured true crop characteristics and a total of each of the measured harvested crop characteristics.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for calibrating a yield monitor, comprising:
delivering a first harvested crop load of a field from a first harvester to a cart, the first harvester including a harvester yield monitor and the cart including a cart sensor;
measuring a harvested crop characteristic of the first harvested crop load with the harvester yield monitor;
calibrating the harvester yield monitor based on the harvested crop characteristic and a true crop characteristic, the calibration including:
measuring the true crop characteristic of the first harvested crop load with the cart sensor,
comparing the true crop characteristic to the harvested crop characteristic measured with the yield monitor of the first harvester,
calibrating the yield monitor of the first harvester based on the comparison; and
repeating calibrating with on-going delivering of at least one subsequent harvested crop load from the first harvester to the cart and measuring of a subsequent harvested crop characteristic; and
providing a harvested crop yield map of the field based on the calibrating.

2. The method of claim 1, further comprising:
measuring a true crop characteristic of each of a plurality of harvested crop loads from a plurality of harvesters in addition to the first harvester;
comparing the true crop characteristics of each of the plurality of harvested crop loads in addition to the first harvested crop load to respective yield monitor crop characteristics of each of the plurality of harvesters including the first harvester; and
calibrating the yield monitor of each of the plurality of harvesters based on the respective comparison of each the plurality of yield monitor crop characteristics and true crop characteristics.

3. The method of claim 1, further comprising:
measuring a true crop characteristic with the cart sensor of each of a plurality of harvested crop loads from a plurality of harvesters other than the first harvester;
comparing the true crop characteristics of each of the plurality of harvested crop loads other than that of the first harvester to respective yield monitor crop characteristics of each of the plurality of harvesters to provide a plurality of comparisons; and
determining a normalized comparison from the plurality of comparisons and the comparison associated with the first harvester;
calibrating the yield monitor of each of the plurality of harvesters and the first harvester based on the normalized comparison.

4. The method of claim 1, further comprising calibrating a yield monitor of each of a plurality of harvesters including than the first harvester based on the comparison associated with the first harvester.

5. The method of claim 1, wherein measuring the yield monitor crop characteristic and the true crop characteristic includes measuring at least one of a crop weight, a crop moisture content, a crop temperature, and a crop volume.

6. The method of claim 1, further comprising transmitting the true crop characteristic to the first harvester, such that the yield monitor performs the comparing.

7. The method of claim 6, further transmitting the comparison from the first harvester to a database.

8. The method of claim 7, further comprising:
logging a plurality of comparisons to provide a comparison log;
analyzing the comparison log to determine a historical comparison; and
providing the historical comparison to the first harvester.

9. The method of claim 1, further comprising transmitting a calibration instruction based on the comparison to the first harvester, such that the cart performs the comparing.

10. The method of claim 9, further comprising:
storing a plurality of calibration instructions as a calibration instruction log, the plurality of calibration instructions based on comparisons between harvested crop characteristics and corresponding true crop characteristics;
generating a historical calibration value based on the calibration instruction log; and
wherein calibrating the yield monitor of the first harvester based on the comparison includes calibrating the yield monitor with the historical calibration value.

11. The method of claim 1, further comprising adjusting the measured yield monitor crop characteristics of respective previously harvested crop loads based on the calibrating.

12. The method of claim 1, further comprising adjusting a harvested crop yield map based on the calibrating.

13. The method of claim 1, wherein delivering the first harvested crop load includes delivering at least one of grains, fruits, vegetables, nuts, cotton, and tobacco.

14. The method of claim 1, wherein delivering the first harvested crop to the cart includes delivering to one of a truck, a crop cart, a tractor, a semi-trailer, or an elevator.

15. A system, comprising:
a harvester yield monitor configured for installation with a first harvester, the harvester yield monitor configured to measure a harvested crop characteristic, including a position, of a first harvested crop load of a field as the field is harvested;
a cart sensor configured for installation with a cart, the cart sensor measures a true crop characteristic of the first harvested crop load;
a calibration module in communication with the harvester yield monitor and the cart sensor, the calibration module includes:
a comparator, the comparator compares the measured harvested crop characteristic with the measured true crop characteristic to provide a series of comparisons, and
a calibration instruction module, the calibration instruction module generates a calibration instruction for the harvester yield monitor based on the comparison; and
a computer configured to receive the series of comparisons and to adjust a yield map of the first harvested crop to reflect the actual crop characteristic of the field by position within the field.

16. The system of claim 15, the calibration module further comprised to compare the true crop characteristic to the yield monitor crop characteristic and determine a calibration instruction.

17. The system of claim 15, further comprising a plurality of harvesters other than the first harvester, each of the plurality of harvesters includes a respective yield monitor, wherein the first harvester transmits at least one of the comparison and the calibration instruction to each of the plurality of harvesters.

18. The system of claim 15, further comprising:
a historical comparison module, the historical comparison module stores a plurality of comparisons as a comparison log and the historical comparison module generates a historical comparison value based on the comparison log; and
a historical calibration instruction module, the historical calibration instruction module stores a plurality of calibration instructions as a calibration instruction log, the plurality of calibration instructions based on the comparison and the historical calibration instruction module generates a historical calibration value based on the calibration instruction log,
wherein the calibration module is in communication with the historical comparison module and the historical calibration instruction module.

19-20. (canceled)
